(19) United States
(12) Patent Application Publication
(10) Pub. No.: US 2009/0187505 A1
(43) Pub. Date: Jul. 23, 2009

(54) ONLINE SAVINGS NETWORK

(76) Inventor: Dan Ariely, Durham, NC (US)

Correspondence Address: FISH & RICHARDSON P.C., P.O. BOX 1022, MINNEAPOLIS, MN, 55440-1022, US

(21) Appl. No.: 12/016,407

(22) Filed: Jan. 18, 2008

(51) Int. Cl. G06Q 40/00

(52) U.S. Cl. 705/39

(57) ABSTRACT

Implementing an online savings network includes creating a network account for an owner and associating an investment account to the network account. The investment account is associated with savings parameters and is owned by the owner. A first contributor is invited to join the online savings network and a condition is established in response to an input by the first contributor that, when satisfied, triggers an automatic contribution of financial assets to the investment account by the first contributor, wherein the financial assets have a value that is relative to a value of a contribution by the owner.

### TECHNICAL FIELD

This disclosure relates to online savings networks.

### BACKGROUND

Online social networking websites are popular destinations on the Internet. Typically, they are used to keep in touch with friends and classmates, to find potential romantic interests, to find a referral for employment opportunities, or to find other users with shared interests in music, movies, books, or television shows. Also, they provide a convenient way for a person to show their interests, hobbies, experience or as an outlet for their own creative works (e.g., songs, short movies, writings).

Typically a user joins the online social networking website and then customizes his home page to reflect his interests or experiences. The user then invites his friends, family members or contacts to join the online social network and create a sub-network (i.e., a network within the online social network comprised of the user's friends, family members or contacts). The user can send messages to other members of the website.

### SUMMARY

The details of one or more implementations of the invention are set forth in the accompanying drawings and the description below.

In one aspect, implementing an online savings network includes creating a network account for an owner and associating an investment account to the network account. The investment account is associated with savings parameters and is owned by the owner. A first contributor is invited to join the online savings network and a condition is established in response to an input by the first contributor that, when satisfied, triggers an automatic contribution of financial assets to the investment account by the first contributor, wherein the financial assets have a value that is relative to a value of a contribution by the owner.

Other features and advantages will be apparent from the following description, the accompanying drawings, and the claims.

### BRIEF DESCRIPTION OF THE DRAWINGS

FIG. 1 is a block diagram of an example online savings network.

FIG. 2 is a block diagram of a second example online savings network.

FIG. 3 is a flowchart illustrating an example process to create an online savings sub-network.

FIG. 4 is a flowchart illustrating an example process for a contributor to contribute to an owner's savings goals.

FIG. 5 is a flowchart illustrating an example process to create a challenge.

FIG. 6 is a block diagram of an example system implementing an online savings network.

### DETAILED DESCRIPTION

Various aspects of the system may be implemented in hardware, software or a combination of hardware and software. Circuitry, including dedicated or general purpose machines, such as computer systems and processors, may be adapted to execute machine-readable instructions to implement the techniques described above. Computer-executable instructions for implementing the techniques can be stored, for example, as encoded information on a computer-readable medium such as a magnetic floppy disk, magnetic tape, compact disc read only memory (CD-ROM), or other machine-readable medium.

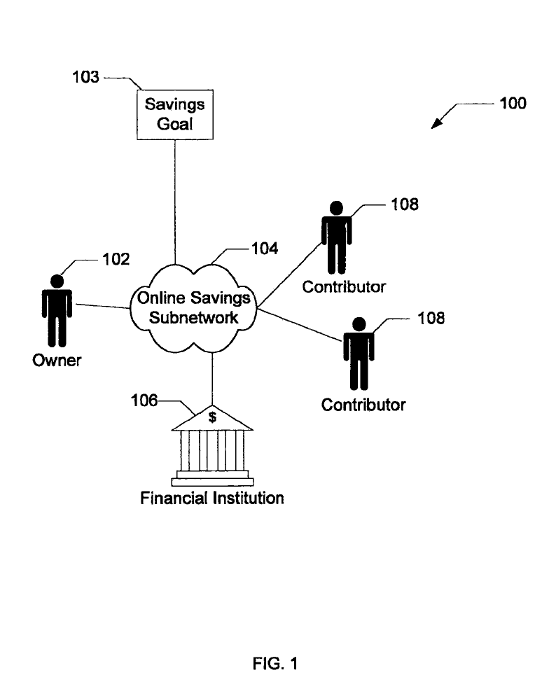

FIG. 1 illustrates an example of an online savings network 100. The online savings network 100 comprises at least one owner 102, at least one savings goal 103, at least one online savings sub-network 104, a financial institution 106 and at least one contributor 108. The owner 102 can be a person or an entity such as a charity, a club (e.g., a school group), or some other entity that owns an investment account. The owner 102 forms the online savings sub-network 104 by choosing the financial institution 106 and defining one or more savings goals 103.

The savings goal 103 represents an item or purpose that the owner 102 is saving for. The savings goal 103 has different savings parameters such as a target savings value (e.g., $100,000.00), expected maturation time (e.g., how many months or years until the money will be withdrawn or used), method of investment, and an identified purpose (e.g., paying for college tuition or buying a car). The method of investment may be any type of investment vehicle such as stocks, bonds, mutual funds, and/or money market accounts. For example, a savings goal 103 can have an identified purpose of paying college tuition with a target savings value of $100,000.00, an investment method of stocks and a maturation time of ten years. Another example is a savings goal 103 with an identified purpose of “general savings,” a target value equal to six months of monthly costs (e.g., housing costs, groceries, insurance, bills) to be invested in a money market account and a maturation time of “as soon as possible.”

The online savings sub-network 104 connects the savings goal 103 to a financial institution 106 and to contributors 108. The financial institution 106 can be any type of financial institution that provides investment vehicles such as money market accounts, stocks, mutual funds, and/or bonds. The owner 102 chooses the type of investment vehicle to be the method of investment associated with each savings goal 103.

The owner 102 then invites family members, friends and/or contacts to join the online savings sub-network 104 as a contributor 108 and to contribute toward the owner's 102 savings goal 103. Alternatively, a contributor 108 can ask the owner 102 to join the online savings sub-network 104. The contributor 108 can be a member of one or more online savings sub-networks 104.

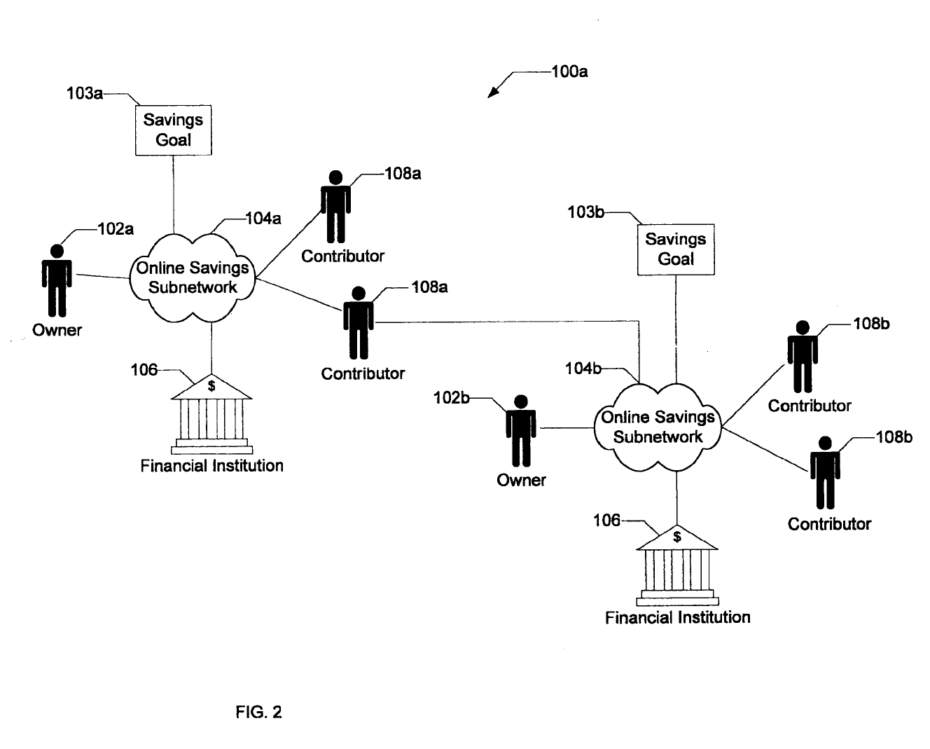

FIG. 2 illustrates an example of the online savings network 100a comprising owners 102a and 102b, savings goals 103a and 103b and online savings sub-networks 104a and 104b. Owner 102a forms the online savings sub-network 104a and defines at least one savings goal 103a. Owner 102b forms the online savings sub-network 104b and defines at least one savings goal 103b. The financial institutions 106a and 106b are associated with the online savings sub-networks 104a and 104b, respectively, and can be different financial institutions or can be the same financial institution.

Owner 102a invites friends, family members and/or contacts to join his online savings sub-network 104a as a contributor 108a, and owner 102b invites his friends, family members and/or contacts to join his online savings sub-network 104b as a contributor 108b. The contributors 108a can contribute to the savings goals 103a associated with the online savings sub-network 104a, and the contributors 108b can contribute to the savings goals 103b associated with the online savings sub-network 104b. Each contributor 108 can be a member of one or more online savings networks 104. For example, a contributor 108a can be a member of the online savings sub-network 104a and also can be a member of the online savings sub-network 104b.

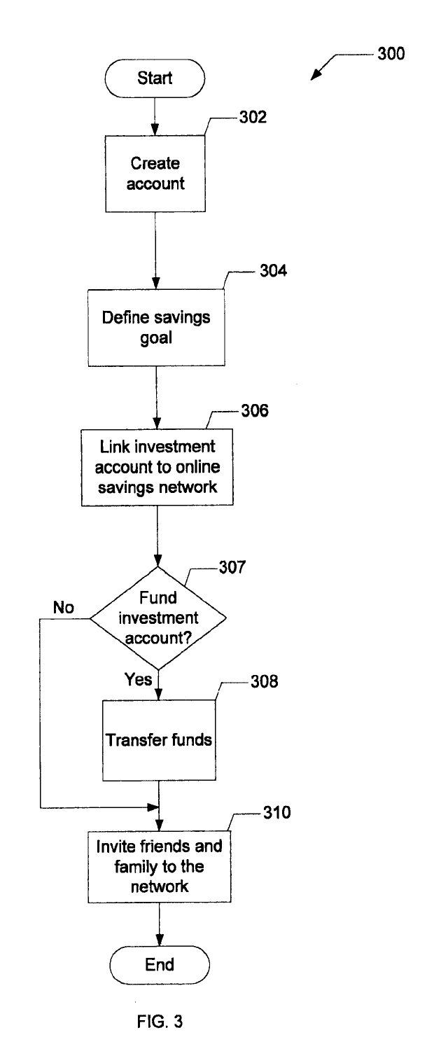

FIG. 3 is a flowchart illustrating a process 300 to create an online savings sub-network 104. An owner 102 joins an online savings network 100 and creates an account (block 302). The account allows the owner 102 to choose a user name and a password, and allows the owner 102 to enter other information such as contact information and/or a nickname. After the account is opened, the owner 102 has a savings homepage on the online savings network 100.

The owner 102 then defines one or more savings goals 103 and defines savings parameters for each savings goal 103 (block 304). The savings parameters can include, but are not limited to, an identified purpose, a maturation time, a method of investment, and/or a target savings value. For example, the owner 102 may define a savings goal 103 with a savings purpose of paying for college tuition, a maturation time of ten years, to be invested in mutual funds, and a target savings value of $100,000. The owner's savings homepage is updated to display the savings goal 103 and the savings parameters.

The owner 102 then opens an investment account at a financial institution 106 that is associated with the owner's account on the online savings network 100, or the owner 102 can link an existing investment account at a financial institution 106 (i.e., an investment account that was opened before the owner created an account on the online savings network 100) to the owner's account on the online savings network 100 (block 306). Alternatively, the owner 102 can open multiple investment accounts at the financial institution 106 and associate them with the owner's account on the online savings network 100. The owner 102 can open the investment account directly through the online savings network 100, or the owner 102 can open the investment account separate from the online savings network 100 and have it linked to his account on the online savings network 100. In one implementation, the savings parameters may be associated with the investment account at the financial institution 106.

The owner 102 then decides if he wishes to fund his investment account (block 307). If the owner 102 decides not to fund his investment account, the process 300 skips to block 310. However, if the owner 102 chooses to fund his investment account, the owner 102 can transfer money into the investment account at the financial institution 106 and apply a percentage of the money to each savings goal 103 (block 308). For example, the owner 102 can transfer 60% of the money to a first savings goal 103, 10% of the money to a second savings goal 103, and the remaining 30% of the money to a third savings goal 103. After the investment account is funded, the owner's savings homepage is updated to display the savings goal 103, the savings parameters associated with the savings goal 103 and the amount of money associated with each savings goal 103. The amount of money associated with each savings goal 103 is updated after any contribution by the owner 102 or a contributor 108.

The owner 102 then invites friends, family members, and/or contacts to join the online social network 100 as a contributor 108 and become members of the owner's online social sub-network 104 (block 310). The owner 102 can invite friends, family members, and/or contacts, for example, by sending them an email or personally contacting them.

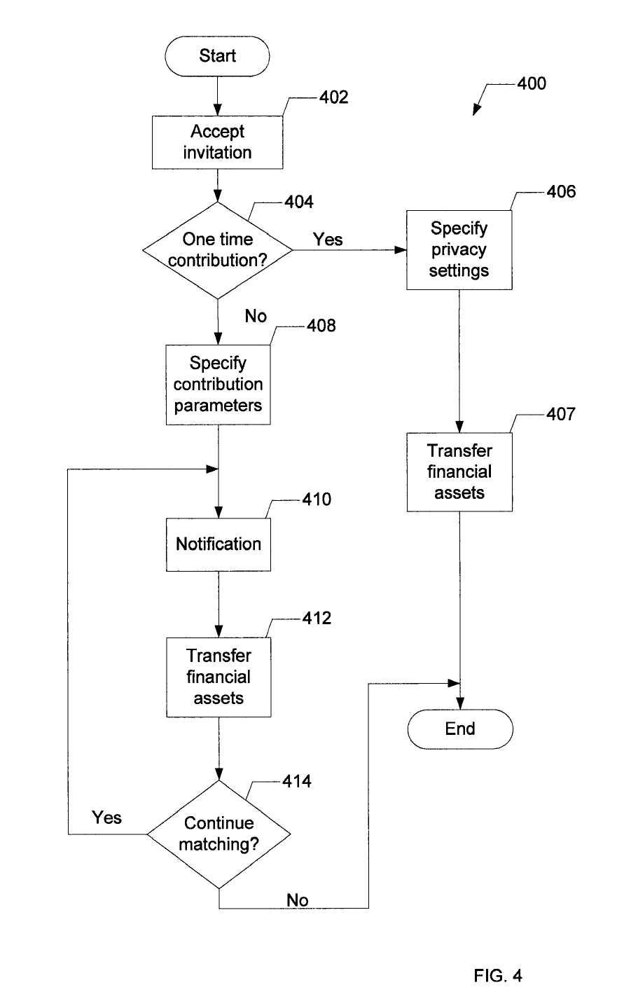

FIG. 4 is a flowchart illustrating a process 400 for a contributor 108 to make contributions toward the owner's savings goals 103. The contributor 108 accepts the invitation from the owner and creates an account on the online savings network 100 (block 402). Similar to the owner's account, the contributor's account allows the contributor 108 to create a user name and password and allows the contributor 108 to enter other additional information such as contact information. After the contributor's account is created on the online savings network 100, the contributor 108 becomes part of the owner's online savings sub-network 104 and is able to view the owner's savings homepage. The contributor 108 can view the owner's savings goals 103, the amount the owner 102 has already saved and information about other members of the online savings sub-network 104.

The contributor 108 then decides if he will make a one-time contribution to the owner's savings goal 103 or make a recurring (e.g., periodic) contribution (block 404). If the contributor 108 decides to make a one-time contribution, the contributor 108 specifies his privacy settings (block 406). The privacy settings allow the contributor 108 to control how much information related to his contribution is visible to other members of the owner's online savings sub-network 104. For example, the contributor 108 can set the settings to allow his contribution to be visible to all the members of the online saving sub-network 104, or the contributor 108 can choose to have his identity hidden even though the amount of its contribution is visible to other members in the online savings sub-network 104.

The contributor 108 then transfers financial assets (e.g., cash, stocks, or bonds) to the owner's investment account (block 407). Any method of transferring financial assets into the owner's investment account at the financial institution 106 may be used. For example, the contributor 108 can transfer money electronically into the owner's investment account or deposit money into the owner's investment account at the financial institution 106. The contributor 108 can divide his contribution into the different savings goals 103 or can apply the entire contribution to a single savings goal. After the one-time contribution is made, the process 400 ends.

If the contributor 108 decides to make a recurring contribution, then the contributor 108 specifies contribution parameters for his recurring contributions (block 408). The contribution parameters include, but are not limited to, an amount to be contributed, a matching period (i.e., a frequency of contribution such as weekly, monthly or yearly), maximum contribution limits (e.g., limits for tax purposes), a method of contribution (e.g., transfers of cash, stocks or bonds), the savings goal 103 that will be contributed to and/or a matching-notification (e.g., an email alerting the contributor 108 of the need to make a contribution that is sent before the contribution is required from the contributor 108). The amount to be contributed can be a fixed amount or can be an amount that is relative to some predetermined percentage of the owner's own contribution over a period of time (e.g., a matching rate). For example, the contributor 108 can choose a monthly matching rate of 10% (e.g., a contribution amount that is equal to 10% of the amount the owner 102 contributed to the savings goal 103 during the month). Any percentage and any time period can be used. The matching-notification can be any type of notification such as an email, text message, or instant message. The matching-notification can be customized such that it is sent a predetermined number of days before the matching period ends (i.e., when the contribution is required) to allow the contributor to make adjustments to his finances to prepare for the pending contribution. In addition, the contribution parameters control the privacy settings associated with the contributions. The contributor 108 can control the amount of information related to the contribution that is visible to other members of the online savings sub-network 104, as explained above.

The contributor 108 can change the contribution parameters at any time. However, when the contributor 108 makes changes to the contribution parameters, the changes do not go into effect until after the current matching period ends. The changes will not effect the contributor's next contribution, but will go into effect after the contribution is made.

After specifying the contribution parameters, the contributor 108 waits until the online savings network 100 sends a matching-notification (block 410). The matching-notification is sent to the contributor 108 before the contributor's contribution is required and is sent only if the contribution parameters are satisfied. For example, if the contributor 108 chose a monthly matching rate of 10% and the owner 102 did not make any contributions to the savings goal 103 during the month, the matching-notification is not sent to the contributor 108.

When the contributor 108 receives the matching-notification, the contributor 108 is made aware of the need to make a future contribution and the amount of that contribution. For example, if the contributor 108 chose an annual matching rate of 10% and the owner 102 contributed $1000 to the savings goal 103, then the matching-notification would alert the contributor 108 that he is required to transfer $100 (or financial assets valued at $100) into the owner's investment account at the financial institution 106.

When the matching period ends, the contributor 108 transfers financial assets into the owner's investment account at the financial institution 106 (block 412). The transfer of financial assets is performed in accordance with the contribution parameters set in block 408. The transfer of financial assets can be made similar to the transfer of financial assets for the one-time contribution described in block 407.

After the transfer of financial assets is completed, the contributor 108 can continue to contribute to the owner's savings goal 103 if the savings goal 103 has not been satisfied (i.e., the target savings value has been reached) (block 414). If the contributor 108 decides to continue contributing and the savings goal 103 has not been satisfied, the contributor 108 waits until he receives a new matching notification (block 410). If the savings goal 103 has been satisfied or the contributor 108 decides not to continue contributing to the savings goal 103, the process 400 ends.

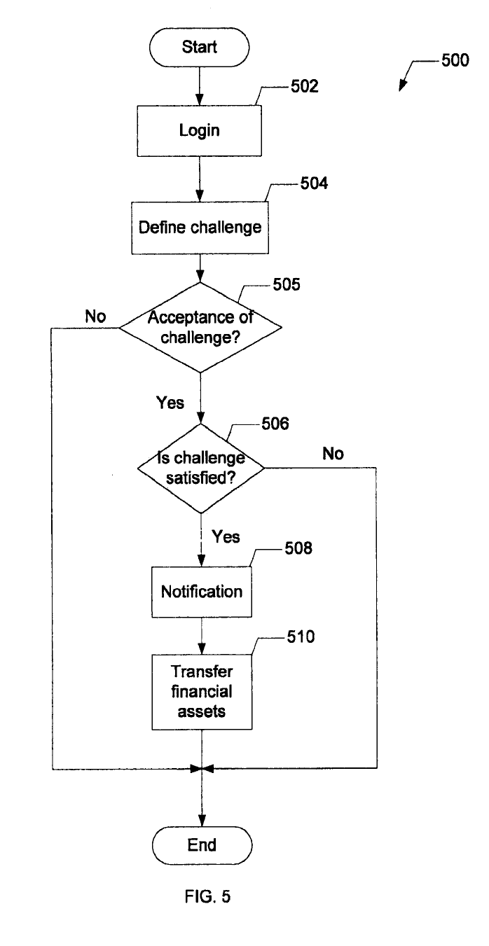

FIG. 5 is a flowchart illustrating a process 500 for a contributor 108 to issue a challenge to other members of the owner's online savings sub-network 104. The contributor 108 logs into the online savings network 100 using the user name and password created in block 402 (block 502). The contributor 108 then creates the challenge (block 504). The challenge is directed at other members of the owner's online savings sub-network 104 and is valid for a predetermined amount of time (i.e., a lifespan). The challenge can be any type of event or condition to be satisfied. For example, the contributor 108 can propose that he will match all contributions that are made to a particular savings goal 103 within a fixed time frame. In a different example, the contributor 108 can propose that he will make a contribution toward the owner's savings goal 103 if the owner 102 attains a specified goal (e.g., good grades in school, performance in athletics, or the contribution is proportional to some other metric). According to another example, the contributor 108 can propose that he will contribute a predetermined amount of money (e.g., $5000) to a particular savings goal 103 if other members of the online savings sub-network 104 also agree to contribute the same amount of money to the particular savings goal 103.

After the challenge is created, the contributor 108 waits until another member of the online savings sub-network 104 accepts the challenge (block 505). The other members of the online savings sub-network 104 learn of the contributor's challenge when they receive a notification sent by the online savings network 100. The notification alerts the members of the owner's online savings sub-network 104 that the contributor 108 has created a challenge and the terms of the challenge. The notification may be any type of notification such as an email, text message, or instant message.

If no member accepts the challenge, then the process 500 ends. If another member accepts the challenge, then the contributor 108 waits until the challenge is satisfied within the lifespan of the challenge (block 506). For example, the contributor 108 waits until the end of the month to determine the total amount contributed to a particular savings goal 103. If the condition is not satisfied within the lifespan of the challenge, the process 500 ends. If the condition is satisfied within the lifespan of the challenge, a challenge-notification is sent to the contributor 108 alerting him that the challenge has been satisfied and informing him of the amount he is required to contribute to the savings goal 103 (block 508). The contributor 108 then transfers financial assets to the owner's investment account as described in block 407 (block 510). The process 500 then ends.

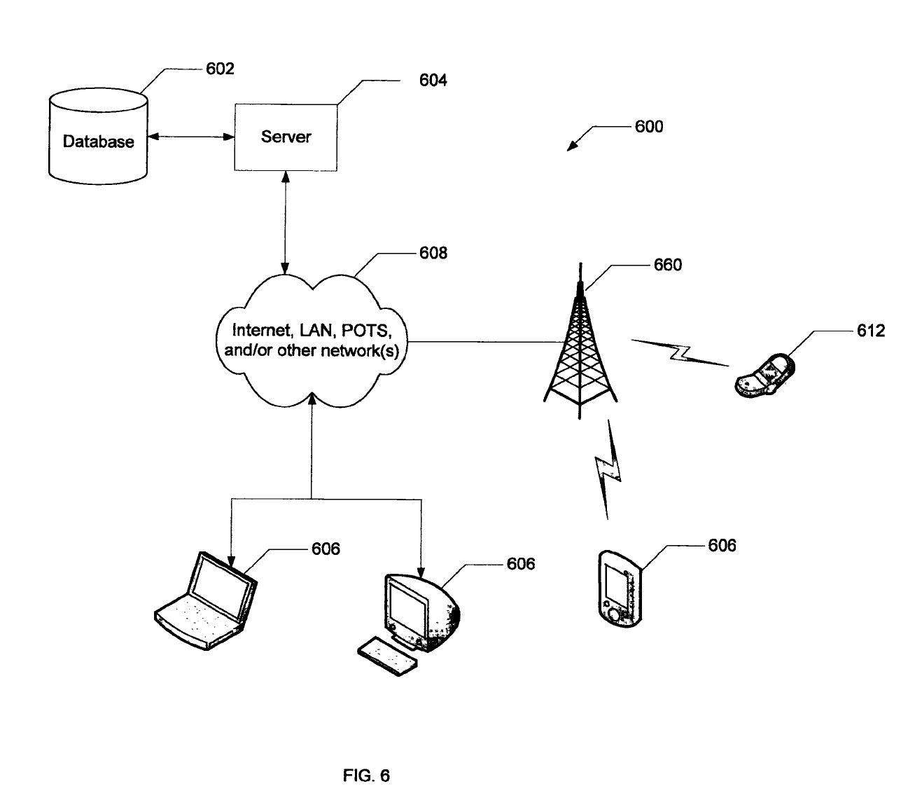

FIG. 6 illustrates an example system that can be used to implement an online savings network 600. The example online savings network 600 includes one or more databases 602 connected to a server 604. The server 604 can be, but is not limited to, any type of dedicated server or personal computer. The database 602 can be contained within the server 604 or can be in a separate storage device or computer.

The server 604 can exchange data with other computing devices 606 via a connection to a communication network 608. The network connection may be any type of network connection, such as an Ethernet connection, digital subscriber line (DSL), telephone line or coaxial cable. The communication network 608 can be any type of network, such as the Internet, a telephone network, a cable network, and/or a wireless network. The computing device 606 may be any type of computing device. For example, the computing device 606 may be a personal computer, a laptop, or a personal digital assistant (“PDA”). The communication network 608 can transmit information from the server 604 to the computing devices 606 or can transmit information from the computing devices 606 to the server 604.

The communication network 608 also can be connected to a wireless transmitter 610. The wireless transmitter 610 can be any type of wireless transmitter such as a cellular telephone transmitter. A cell phone 612 may be connected to the wireless transmitter 610 or any other type of computing device 606 that can receive wireless transmissions from the wireless transmitter 610 such as a PDA configured with a wireless receiver.

A number of implementations of the invention have been described. Nevertheless, it will be understood that various modifications may be made without departing from the spirit and scope of the invention. For example, the maturation time associated with a savings goal 103 may control the owner's access to the funds in the investment account. In such an implementation, the owner 102 would not be able to withdraw the funds in the investment account until the maturation time has expired. Accordingly, other implementations are within the scope of the claims.

What is claimed is:

1. A machine-implemented method for an online savings network comprising:
creating a network account for an owner;
associating an investment account to the network account, wherein the investment account is associated with savings parameters and is owned by the owner;
inviting a first contributor to join the online savings network; and
establishing a condition in response to an input by the first contributor that, when satisfied, triggers an automatic contribution of financial assets to the investment account by the first contributor, wherein the financial assets have a value that is relative to a value of a contribution by the owner.

2. The method of claim 1 further comprising:
inviting a second contributor to join the online savings network; and
establishing a second condition in response to a second input by the first contributor that, when satisfied, triggers an automatic contribution of financial assets to the investment account by the first contributor, wherein the financial assets have a value that is relative to a contribution by the second contributor.

3. The method of claim 2 wherein establishing the second condition comprises proposing a challenge to be satisfied.

4. The method of claim 1 further comprising sending a notification to the first contributor before the automatic contribution of financial assets is made.

5. The method of claim 1 further comprising establishing a recurring condition in response to the input by the first contributor, that when satisfied, triggers the automatic contribution of financial assets to the investment account by the first contributor, wherein the financial assets have a value that is relative to the value of the contribution by the owner.

6. The method of claim 1 wherein the savings parameters comprise:
a savings purpose;
a target value to satisfy the savings purpose;
a maturation time that defines a time frame for the owner to save the target value; and
at least one investment vehicle, wherein the owner's contribution to the investment account is used to fund the investment vehicle.

7. The method of claim 1 wherein the condition comprises:
a matching period;
a contribution rate that is relative to the owner's contribution;
a maximum contribution amount that limits a value of a total contribution to the savings account by the first contributor; and
a notification that alerts the first contributor of a pending contribution of financial assets.

8. The method of claim 3 wherein the challenge is directed at the second contributor and comprises:
a proposed event; and
an amount to be contributed by the first contributor upon the occurrence of the proposed event.

9. The method of claim 8 further comprising sending a notification to the first contributor before the automatic contribution of financial assets is made.

10. A system to implement an online savings network comprising:
a computing device coupled to a server through a communications network, wherein the server is configured to:
receive a first input from an owner to create a network account and to link an investment account at a financial institution to the network account, wherein the investment account is associated with savings parameters;
create an entry in a database in response to the first input;
receive a second input from the owner to invite a first contributor to join the online savings network;
send an invitation to the first contributor in response to the second input;
receive a third input from the first contributor to establish a condition, that when satisfied, triggers a contribution of financial assets to the investment account by the first contributor, wherein the financial assets have a value that is relative to a value of the owner's contribution; and
send a notification to the first contributor after the condition is satisfied.

11. The system of claim 10 wherein the server is configured to:
receive a fourth input to invite a second contributor;
send an invitation to the second contributor in response to the fourth input;
receive a fifth input from the first contributor to establish a second condition, that when satisfied, triggers a contribution of financial assets to the investment account by the first contributor, wherein the financial assets have a value that is relative to a value of a contribution by the second contributor; and
send a notification to the first contributor after the condition is satisfied.

12. An article comprising a machine-readable-medium storing machine-executable instructions that, when applied to a machine, cause the machine to:
create a network account for an owner;
associate an investment account to the network account, wherein the investment account is associated with savings parameters and is owned by the owner;
invite a first contributor to join the online savings network; and
establish a condition in response to an input by the first contributor that, when satisfied, triggers an automatic contribution of financial assets to the investment account by the first contributor, wherein the financial assets have a value that is relative to a value of a contribution by the owner.

13. The article of claim 12 further including instructions that, when applied to the machine, cause the machine to:
invite a second contributor to join the online savings network; and
establish a second condition in response to a second input by the first contributor that, when satisfied, triggers an automatic contribution of financial assets to the investment account by the first contributor, wherein the financial assets have a value that is relative to a contribution by the second contributor.

14. The article of claim 12 further including instructions that, when applied to the machine, cause the machine to establish a recurring condition in response to the input by the first contributor, that when satisfied, triggers the automatic contribution of financial assets to the investment account by the first contributor, wherein the financial assets have a value that is relative to the value of the contribution by the owner.
